(19) United States
(12) Patent Application Publication
(10) Pub. No.: US 2011/0025074 A1
(43) Pub. Date: Feb. 3, 2011

(54) DUAL PAWL GLOVE BOX LATCH ASSEMBLY

(76) Inventor: Jason Reznar, Redford, MI (US)

Correspondence Address: MCDONALD HOPKINS LLC, 600 Superior Avenue, East, Suite 2100, CLEVELAND, OH, 44114-2653, US

(21) Appl. No.: 12/845,507

(22) Filed: Jul. 28, 2010

Related U.S. Application Data
(60) Provisional application No. 61/271,928, filed on Jul. 28, 2009.

(51) Int. Cl. E05C 1/10; E05B 3/00

(52) U.S. Cl. 292/33; 292/336.3

(57) ABSTRACT

A dual pawl latch assembly is described herein. The dual pawl glove box latch assembly may provide an improved latch assembly for a glove box that may reduce the number of assembly components as well as decrease the complexity of those components, such as eliminating screw attachments. The glove box latch assembly may include a handle assembly and a latch assembly. The handle assembly may include a handle and at least one actuating arm extending therefrom. The latch assembly may include a back plate comprising at least one arm aperture and a locking feature comprising an engagement section and a pair of pawls. The actuating arms may engage with the engagement feature to operate the pawls. The glove box latch assembly may also reduce or eliminate chattering on the extended corners of the glove box door when in a closed position.

### CROSS-REFERENCE TO RELATED APPLICATION

This application claims benefit from U.S. Provisional Patent Application No. 61/271,928, entitled “Dual Pawl Glove Box Latch Assembly,” filed on Jul. 28, 2009, which is hereby incorporated by reference in its entirety.

### FIELD OF INVENTION

The present invention is generally related to a latch mechanism and, more particularly, to a dual pawl glove box latch assembly.

### BACKGROUND

A variety of latching mechanisms have been used within the automotive industry for releasably coupling various movable components to a vehicle body. For example, latches may often be used for releasably coupling doors (e.g. passenger doors, liftgate, hood, deck lid, trunk, glove box, etc.) to vehicles. A glove box door may be hingedly mounted to an instrument panel to allow for pivotal movement between a closed position and an open position. In order to keep the door or handle of the glove box in the closed position, a latching mechanism may be provided.

The latching mechanisms may generally be operable in a latched mode to secure the door to the vehicle body and in an unlatched mode where the door may be freely movable relative to the vehicle body. Typically, the latching mechanism may include a striker to be mounted to the instrument panel structure. Strikers may include a latch bar for the glove box latch to “strike” and close around. Strikers may also include a striker bar for latching the glove box door in a closed position. The striker bar may typically be fixed to the instrument panel facing the surface of the door.

The latch may typically be secured near an edge of the door, and a striker may typically be secured to the vehicle body. Generally, only one edge of a door may be releasably coupled to the vehicle body by way of one or more hinge mechanisms. The latch may typically be mounted to an edge opposite that of the hinge mechanism. The side edges of the door are generally not hinged or physically connected to the vehicle body.

The handle may be located in a recess in the door of the glove box so as to offer a pleasing appearance, as well as to reduce the number of possible physical obstructions on the dashboard or center console. Pulling on the handle may result in the rotational motion thereof being transferred to a mechanical linkage that may transform the rotational motion into a linear motion to retract the bolt.

Traditionally, vehicle glove box door latching mechanisms may be complex multi-component devices that are narrowly designed to satisfy the requirements of specific vehicle applications. These glove box door latching mechanisms may often comprise a complex design with a large number of latching components that may result in an undesirable design complexity as well as high manufacturing costs. The large number of components may also increase the risk of part failure. Furthermore, such latching device assemblies may be limited in their flexibility of application due to their design complexity, whereby their design may not allow for placement of the latch closely adjacent to a longitudinal end of a glove box door.

Typical strikers may often require secondary operations as well as additional fastener components to function properly. This adds additional components to the assembly, time for assembly as well as adds to the overall cost. For example, some glove box strikers may require screw attachments to aid in attaching the striker to the instrument panel of the vehicle. In addition, some latch mechanisms may produce noise or chatter on the extended corners of the glove box when closed.

### SUMMARY

A dual pawl latch assembly is described herein. The dual pawl glove box latch assembly may provide an improved latch assembly for a glove box that may reduce the number of assembly components as well as decrease the complexity of those components, such as eliminating screw attachments. The glove box latch assembly may include a handle assembly and a latch assembly. The handle assembly may include a handle and at least one actuating arm extending therefrom. The latch assembly may include a back plate comprising at least one arm aperture and a locking feature comprising an engagement section and a pair of pawls. The actuating arms may engage with the engagement feature to operate the pawls. The glove box latch assembly may also reduce or eliminate chattering on the extended corners of the glove box door when in a closed position.

### BRIEF DESCRIPTION OF THE DRAWINGS

Objects and advantages together with the operation of the invention may be better understood by reference to the following detailed description taken in connection with the following illustrations, wherein:

FIG. 1 illustrates an exploded perspective view of a dual pawl latch assembly in a glove box environment.

FIG. 2 illustrates a perspective view of a handle assembly of the latch assembly of FIG. 1.

FIG. 3 illustrates an exploded perspective view of the handle assembly of FIG. 2.

FIG. 4 illustrates a perspective view of a latch assembly of the latch assembly of FIG. 1.

FIG. 5 illustrates an exploded view of the latch assembly of FIG. 4.

FIG. 6 illustrates a cross-sectional side view of the handle assembly engaged with the latch assembly in a closed position.

FIG. 7 illustrates a cross-sectional side view of the handle assembly engaged with the latch assembly in an open position.

FIG. 8 illustrates a close up view of the engagement of FIG. 7.

FIG. 9 illustrates a cross-sectional side view of the handle assembly and the latch assembly prior to installation in a glove box environment.

FIG. 10 illustrates a cross-sectional side view of an attachment feature of the dual pawl glove box latch assembly.

FIG. 11 illustrates a detailed view of the attachment feature of FIG. 10.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

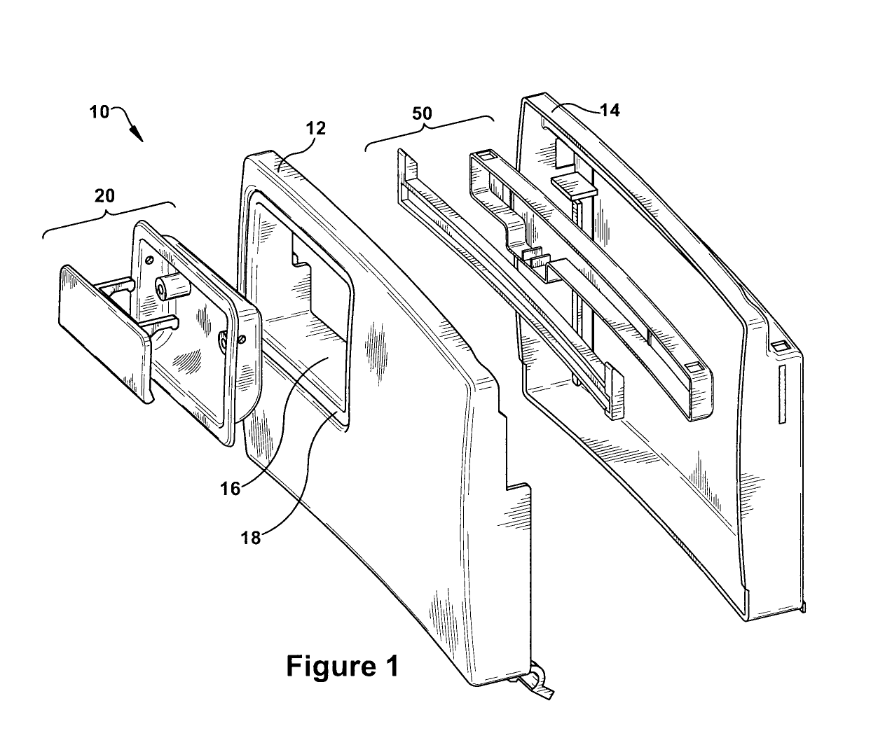

A dual pawl glove box latch assembly 10 is illustrated in FIGS. 1 and 6-11. The dual pawl glove box latch assembly 10 may be of any appropriate shape, size, type or configuration. The glove box latch assembly 10 may include a handle assembly 20 and a latch assembly 50. The dual pawl glove box latch assembly 10 may provide an improved latch assembly for a glove box (not shown) that may reduce the number of assembly components as well as decrease the complexity of those components, such as eliminating screw attachments. In addition, the glove box latch assembly 10 may reduce or eliminate chattering on the extended corners of the glove box door 12, 14 when in a closed position.

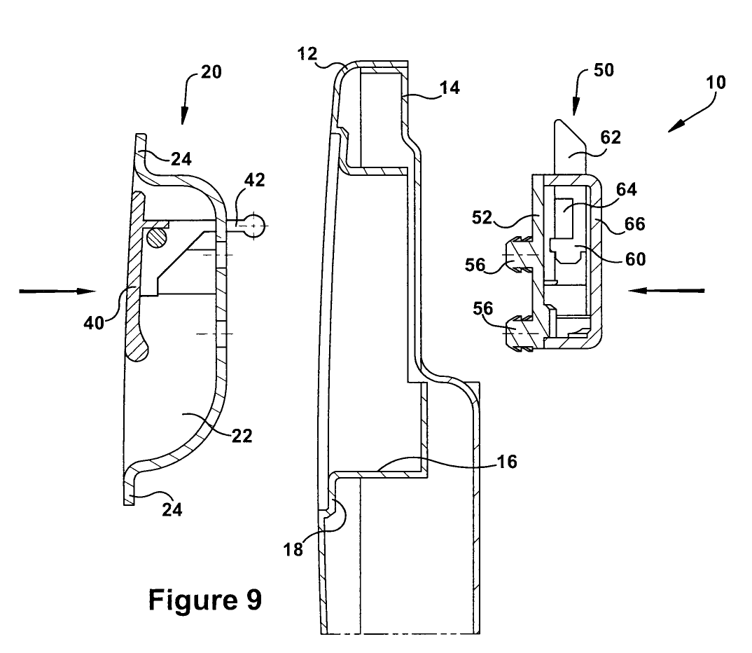

The glove box latch assembly 10 may be a self contained assembly thereby eliminating the need for fastener or screw attachments. For example, the handle assembly 20 may snap into the latch assembly 50 thereby reducing assembly time (FIG. 9). Typical glove box handles and strikers often include mounting screws, such as a minimum of approximately two screws, for example, to mount the handle to the door and may also include approximately two screws, for example, to mount the striker to the glove box.

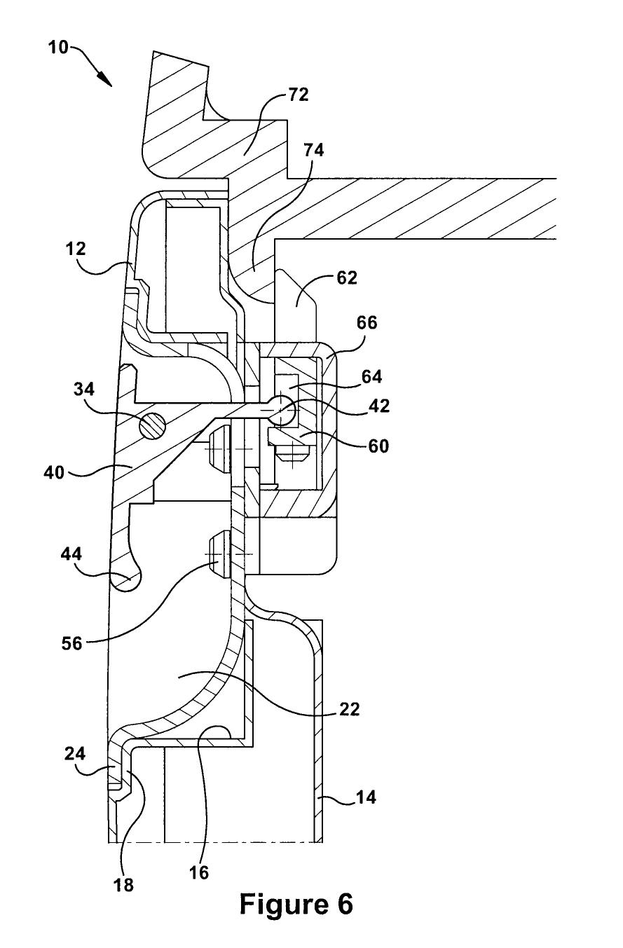

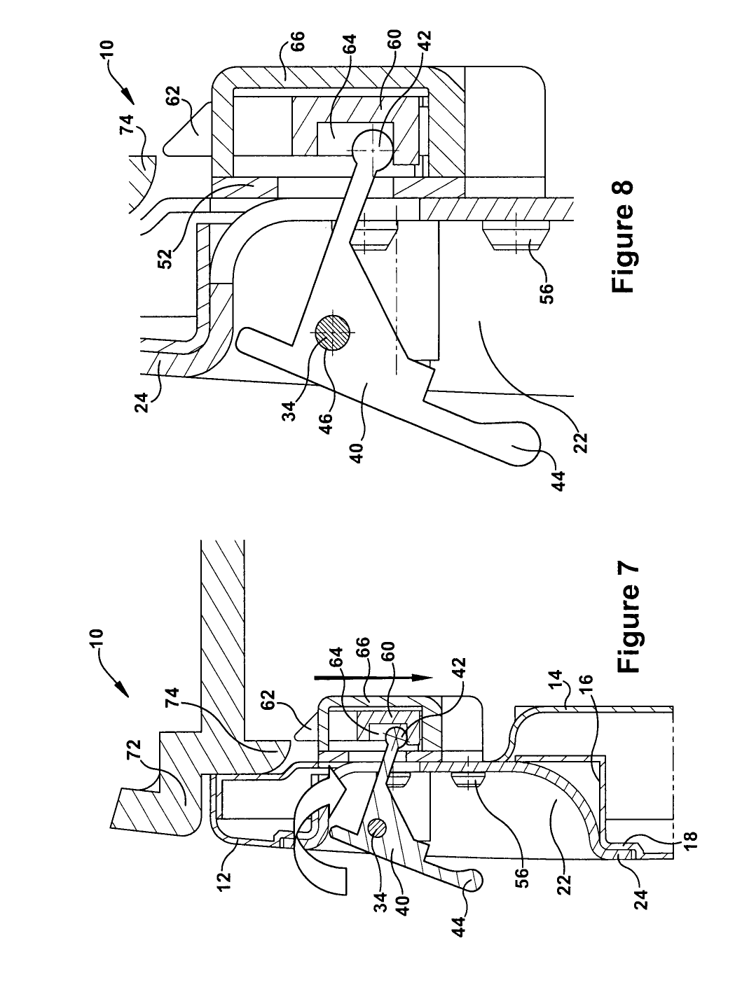

The glove box door 12, 14 may be of any appropriate shape, size, type or configuration. For example, the glove box door 12, 14 may include any appropriate number of panels, such as an outer panel 12 and an inner panel 14 (FIG. 1). The outer and inner panels 12, 14 may be of any appropriate shape or size, such as of a generally similar square or rectangular shape. The outer panel 12 may generally be facing outward from an instrument panel 72 of a vehicle (not shown) (FIGS. 6 and 7).

The outer glove box door panel 12 may include an opening 16 (FIG. 1). The opening 16 may be of any appropriate shape or size, such as a generally square or rectangular shape. For example, the opening 16 may be of a correspondingly similar shape and size as that of the handle assembly 20, whereby the handle assembly 20 may fit within the handle opening 16. The handle opening 16 may be located at any appropriate position on the outer panel 12, such as in the approximate center or to either side of the outer panel 12.

The outer panel 12 may also include a ledge 18 (FIG. 1). The ledge 18 may be of any appropriate shape or size, such as a generally planar surface. The ledge 18 may be located at any appropriate position on the outer panel 12, such as being located around a portion of the handle opening 16. For example, the ledge 18 may be located around the entire handle opening 16 (FIG. 1). The ledge 18 may provide an indented planar surface for the handle assembly 20 to sit within (FIGS. 1, 5 and 6).

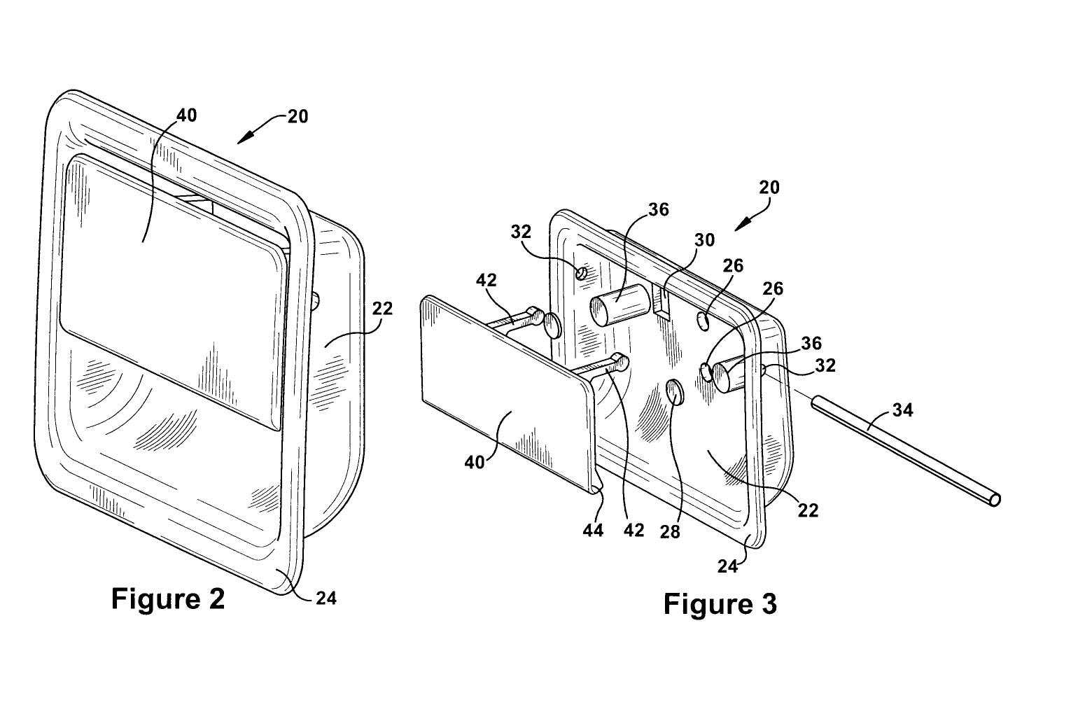

The handle assembly 20 may be of any appropriate shape, size, type or configuration. For example, the handle assembly 20 may be of a generally square or rectangular shape. The handle assembly 20 may be located at any appropriate position on the glove box latch assembly 10, such as within the handle opening 16 of the outer panel 12 (FIG. 1). The handle assembly 20 may include a housing 22 and a handle 40 (FIGS. 2 and 3).

The housing 22 may be of any appropriate shape, size, type or configuration. For example, the housing 22 may be of a generally square, rectangular or circular shape that may generally be an open box. The housing 22 may be located at any appropriate position on the glove box latch assembly 10. The housing 22 may include a rim 24 (FIGS. 2 and 3). The rim 24 may be of any appropriate shape, size, type or configuration, such as a generally planar shape.

The rim 24 may be located at any appropriate position on the housing 22, such as located around a portion of an outer edge of the housing 22. For example, the rim 24 may be located around the entire outer edge of the housing 22 (FIGS. 2 and 3). The rim 24 may abut and rest within the ledge 18 of the outer glove box panel 12, whereby the handle assembly 20 may be centered and maintained within the handle opening 16 (FIGS. 5, 6 and 9).

The housing 22 may include at least one attachment aperture 26, at least one arm aperture 30 and at least one pin aperture 32 (FIG. 3). The housing 22 may include any appropriate number of attachment apertures 26. For example, there may be a pair of attachment apertures 26. The attachment apertures 26 may be of any appropriate shape, size, type or configuration. For example, the attachment apertures 26 may be of a generally square, rectangular or circular shape. The attachment apertures 26 may be located at any appropriate position on the housing 22, such as at a generally central location on the housing 22.

The housing 22 may include any appropriate number of arm apertures 30 (FIG. 3). For example, there may be a pair of arm apertures 30. The arm apertures 30 may be of any appropriate shape, size, type or configuration. For example, the arm apertures 30 may be of a generally square, circular or rectangular shape. The arm apertures 30 may be located at any appropriate position on the housing 22, such as at a generally central location on the housing 22.

There may be any appropriate number of pin apertures 32. For example, there may be a pair of pin apertures 32. The pin aperture 32 may be of any appropriate shape, size, type or configuration. For example, the pin aperture 32 may be of a generally square or circular shape. The pin aperture 32 may be located at any appropriate position on the glove box latch assembly 10, such as located in each side of the housing 22 at a position generally opposite one another (FIG. 3).

The handle assembly 20 may include at least one fastener 34 (FIGS. 3 and 5-9). The fastener 34 may be of any appropriate shape, size, type or configuration, such as a pin. For example, the fastener 34 may be of a generally cylindrical shape. The fastener 34 may be located at any appropriate position on the handle assembly 20, such as generally near an end of the handle assembly 20. The pin apertures 32 may receive the pin 34 there through.

The handle 40 may be of any appropriate shape, size, type or configuration. For example, the handle 40 may be of a generally square or rectangular shape. The handle 40 may be located at any appropriate position on the handle assembly 20, such as near an end of the housing 22 and adjacent a portion of the rim 24. The handle 40 may include at least one actuating arm 42 and a lifting portion 44 (FIGS. 3 and 5-9).

The handle 40 may include any appropriate number of actuating arms 42. For example, the handle 40 may include a pair of actuating arms 42 (FIG. 3). The handle 40 may include the same number of actuating arms 42 as there are arm apertures 30 on the housing 22, whereby the arm apertures 30 of the housing 22 may receive the actuating arms 42 there through.

The actuating arms 42 may be of any appropriate shape, size, type or configuration. For example, the actuating arms 42 may be of a generally rectangular, cylindrical or tubular shape. The actuating arms 42 may be located at any appropriate position on the handle 40, such as on a back side of the handle 40. For example, the actuating arms 42 may extend in a direction perpendicularly outward from the handle 40 towards the inside of the glove box (FIG. 3).

The lifting portion 44 may be of any appropriate shape, size, type or configuration. For example, the lifting portion 44 may be of a generally rectangular, ovular or cylindrical shape. The lifting portion 44 may be located at any appropriate position on the handle 40, such as adjacent an end of the handle 40 (FIGS. 3 and 5-9). The lifting portion 44 may aid the user in opening the glove box.

Each actuating arm 42 may include a pin aperture 46 (FIG. 8). The pin apertures 46 may be of any appropriate shape, size, type or configuration. For example, the pin apertures 46 may be of a generally circular shape that may be correspondingly similar to that of the pin 34. The pin apertures 46 may be located at any appropriate position on the actuating arms 42. The pin apertures 46 may receive the pin 34 there through.

The housing 22 may also include at least one bumper 28 and at least one protrusion 36 (FIG. 3). The housing 22 may include any appropriate number of bumpers 28. For example, the housing 22 may include a pair of bumpers 28. The bumpers 28 may be of any appropriate shape, size, type or configuration. For example, the bumpers 28 may be of a generally rectangular, square or cylindrical shape. The bumpers 28 may be located at any appropriate position on the housing 22, such as at a generally central location on the housing 22. The bumpers 28 may be fabricated out of any appropriate type of materials, such as rubber.

The housing 22 may include any appropriate number of protrusion 36 (FIG. 3). For example, the housing 22 may include a pair of protrusions 36. The protrusions 36 may be of any appropriate shape, size, type or configuration. For example, the protrusions 36 may be of a generally rectangular, square or cylindrical shape. The protrusions 36 may be located at any appropriate position on the housing 22, such as near an end of the housing 22 adjacent the actuating arms 42. The bumpers 28 and protrusions 36 may reduce or eliminate noise and impact resulting from any contact of the handle 40 and the housing 22 during use of the glove box latch assembly 10.

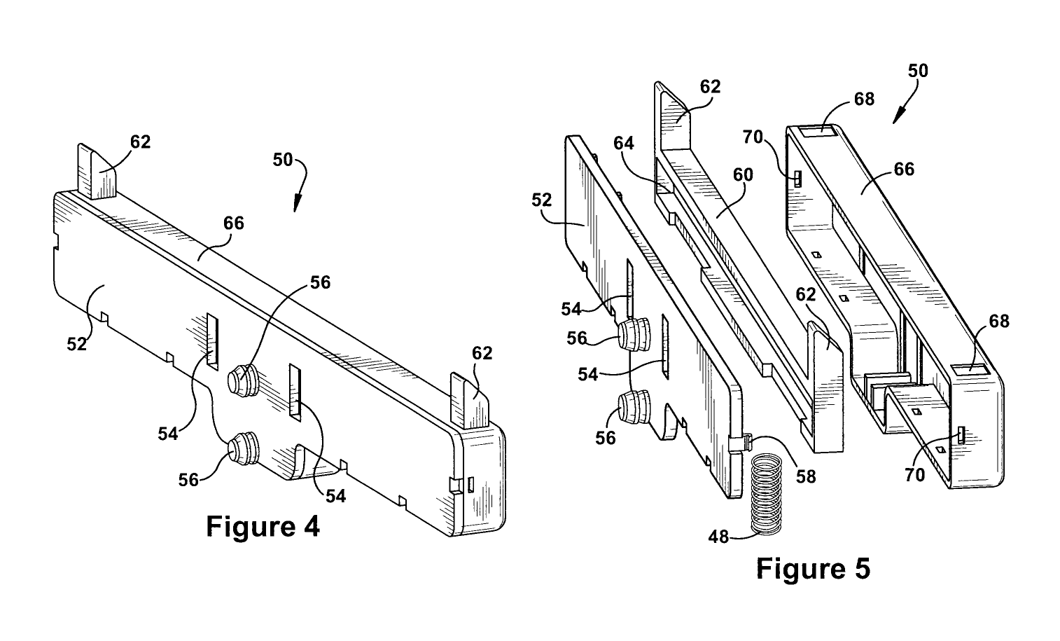

The latch assembly 50 may be of any appropriate shape, size, type or configuration. For example, the latch assembly 50 may be of a generally square or rectangular shape. The latch assembly 50 may be located at any appropriate position on the glove box latch assembly 10, such as located adjacent an inner portion of the outer panel 12 (FIG. 1). The latch assembly 50 may include a back plate 52, a dual pawl locking feature 60 and a pawl cover 66 (FIGS. 4 and 5).

The back plate 52 may be of any appropriate shape, size, type or configuration. For example, the back plate 52 may be of a generally rectangular shape. The back plate 52 may be located at any appropriate position on the latch assembly 50. The back plate 52 may include at least one arm aperture 54 and at least one attachment feature 56 (FIGS. 4 and 5). For example, the back plate 52 may include the same number of arm apertures 54 as there are actuating arms 42 on the handle 40.

The arm apertures 54 may be of any appropriate shape or size, such as a circular or rectangular shape. For example, the arm apertures 54 may be large enough to accommodate the actuating arms 42 there through while in use. The arm apertures 54 may be located at any appropriate position on the back plate 52, such as at a generally central location or adjacent either side of the back plate 52 (FIGS. 4 and 5).

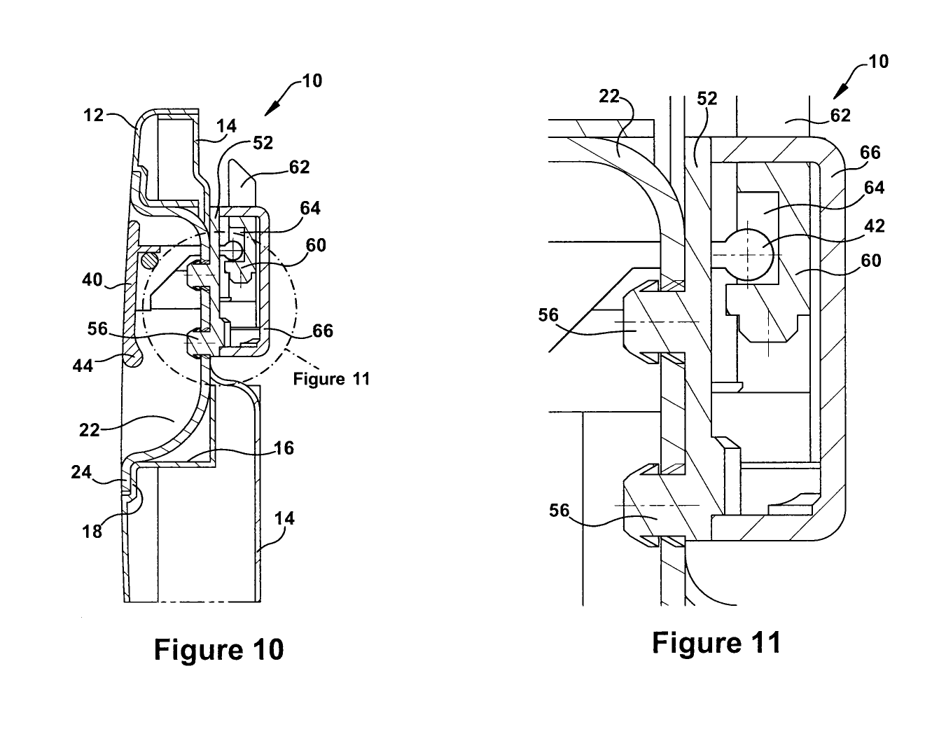

The back plate 52 may include any appropriate number of attachment features 56, such as a pair of attachment feature 56. For example, there may be a correspondingly similar number of attachment features 56 as there are attachment apertures 26 in the housing 22 and vice versa. The attachment features 56 may be of any appropriate shape, size, type or configuration. For example, the attachment features 56 may be of a general Christmas tree style or other snap like design that may fasten the handle assembly 20 to the latch assembly 50 (FIGS. 10 and 11).

The attachment features 56 may be located at any appropriate position on the latch assembly 50, such as at a generally central location or towards either side of the latch assembly 50. The attachment features 56 may be integrally formed with the back plate 52 or separate components that may be attached or inserted through the back plate 52. The attachment features 56 may be inserted into the attachment apertures 26, thereby connecting and securing the handle assembly 20 and latch assembly 50 together.

The dual pawl locking feature 60 may be of any appropriate shape, size, type or configuration. For example, the dual pawl locking feature 60 may be of a generally rectangular shape. The dual pawl locking feature 60 may be located at any appropriate position on the latch assembly 50, such as within or located between the back plate 52 and the pawl cover 66 (FIG. 5).

The dual pawl locking feature 60 may include at least one pawl 62. For example, the dual pawl locking feature 60 may include any appropriate number of pawls 62, such as a pair of pawls 62 (FIGS. 4 and 5). The pawls 62 may be of any appropriate shape, size, type or configuration. For example, the pawls 62 may be of a generally rectangular or triangular shape.

The pawls 62 may be located at any appropriate position on the dual pawl locking feature 60, such as at each end of the locking feature 60. For example, the pawls 62 may extend generally perpendicularly outward from the locking feature 60. Use of the handle 40 may engaged the pawls 62 into a locked or unlocked position with a catch 74 of the instrument panel 72 (FIGS. 6-8).

The locking feature 60 may also include an arm engagement section 64 (FIGS. 5-11). The arm engagement section 64 may be of any appropriate shape, size, type or configuration. For example, the arm engagement section 64 may be of a generally rectangular hollow shape within the locking feature 60, whereby the engagement section 64 may engage or “catch” the end of the actuating arms 42. The arm engagement section 64 may be located at any appropriate position on the locking feature 60, such as within a generally central portion and along the general length of the locking feature 60.

The latch assembly 50 may also include at least one spring 48 (FIG. 5). The spring 48 may be of any appropriate shape, size, type or configuration. The spring 48 may be located at any appropriate position on the latch assembly 50, such as located within and between the back plate 52 and the pawl cover 66. The spring 48 may be utilized to bias the locking feature 60, such as the pawls 62 into a locked or unlocked position with the catch 74 of the instrument panel 72 (FIGS. 6-8).

The pawl cover 66 may be of any appropriate shape, size, type or configuration. For example, the pawl cover 66 may be of a generally hollowed out rectangular shape (FIG. 5). The pawl cover 66 may be of a correspondingly similar shape as that of the back plate 52. The pawl cover 66 may be located at any appropriate position on the latch assembly 50, such as opposite that of the back plate and adjacent to the locking feature 60.

The pawl cover 66 may include any appropriate number of pawl apertures 68, such as a pair of pawl apertures 68. For example, there may be the same corresponding number of pawl apertures 68 as there are pawls 62. The pawl apertures 68 may be of any appropriate shape, size, type or configuration. For example, the pawl apertures 68 may be of a generally square or rectangular shape, whereby the pawls 62 may fit there through (FIG. 4). The pawl apertures 68 may be located at any appropriate position on the pawl cover 66, such as on each end of the pawl cover 66.

The back plate 52 may also include at least one snap protrusion 58 (FIG. 5). There may be any appropriate number of snap protrusions 58. For example, the back plate 52 may include a pair of snap protrusions 58. The snap protrusions 58 may be of any appropriate shape, size, type or configuration. For example, the snap protrusions 58 may be of a generally square, triangular or rectangular shape. The snap protrusions 58 may be located at any appropriate position on the back plate 52, such as located on each side of the back plate 52.

The pawl cover 66 may also include at least one snap aperture 70 (FIG. 5). There may be any appropriate number of snap apertures 70, such as a pair of snap apertures 70. For example, there may be a correspondingly similar number of snap apertures 70 as there are snap protrusions 58. The snap apertures 70 may be of any appropriate shape, size, type or configuration. For example, the snap apertures 70 may be of a generally square, triangular or rectangular shape. The snap apertures 70 may be located at any appropriate position on the pawl cover 66, such as located on each side of the pawl cover 66 adjacent to the snap protrusions 58.

The components of the latch assembly 50 may be assembled in any appropriate manner. For example, the dual pawl locking feature 60 may be sandwiched between the back plate 52 and the pawl cover 66. The components of the latch assembly 50 may be secured together in any appropriate manner, such as with fasteners or the like. For example, in use, the snap apertures 70 may receive the snap protrusions 58 therein, whereby the back plate 52, locking feature 60 and pawl cover 66 may be snapped and attached together.

In use, the handle assembly 20 may actuate or engage the latch assembly 50 to open or close the glove box 12 (FIGS. 6-8). The dual pawl locking feature 60 may be secured to or engaged with the glove box panel 12 (FIG. 6). In addition, the actuating arms 42 may engage with the arm engagement section 64 of the locking feature 60.

As the handle 40 and therein the actuating arms 42 rotate, the actuating arms 42 may engage with the dual pawl locking feature 60 and thereby force the dual pawl locking feature 60 in a downward direction. As the locking feature 60 moves in this downward direction, the glove box door 12, 14 may open and expose the inner compartment of the glove box (FIGS. 7 and 8).

The handle assembly 20 and the latch assembly 50 may be attached or secured together (FIG. 9). Prior to assembly, the handle assembly 20 and the latch assembly 50 may be shipped separately. Once they arrive at the desired destination, a snap of the two assemblies 20, 50 together may sandwich the glove box door panel 12 and thereby fasten the glove box latch assembly 10 system together.

Unlike common latching mechanisms, the dual pawl locking feature 60 of the glove box latch assembly 10 may eliminate chattering on loose corners of glove box door. The dual pawl may latch the corners of the glove box door 12, 14. Typical glove box doors may be approximately 8 to 15 inches in length with a single attachment point in the center. This single attachment point may prevent the corners of the glove box from being firmly locked in place creating a buzz or chattering sound. The glove box latch assembly 10 may lock down the corners and eliminates this noise for the customer. The glove box latch assembly 10 may be located at any appropriate or desired position on the glove box door.

The glove box latch assembly 10 may reduce the number of components by eliminating the need for a spring on the handle assembly and eliminates the need for any separate mounting plate components. The handle assembly housing of the glove box latch assembly 10 may include features in the housing 22 components that may connect or snap into the latch assembly 50. In addition, the glove box latch assembly 10 may also eliminate the need for a separate striker component on the glove box itself to latch the door to the glove box.

Unlike typical latching mechanisms, the glove box latch assembly 10 may include two pawls 62 for latching, and not just a single pawl latch. In addition, the assembly 10 may include features built into the housing 22 that attach the latch/door to the housing 22. The assembly 10 may also be secured through the housing 22 and latching plate thereby eliminating the need for a mounting plate. The glove box latch assembly 10 may also eliminate the need for a torsional spring.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. A glove box latch assembly comprising:
a handle assembly comprising a handle and at least one actuating arm extending outwardly from said handle;
a latch assembly comprising:
a back plate comprising at least one arm aperture;
a locking feature comprising an engagement section and at least two pawls; and
wherein said at least one actuating arm engages with said engagement feature to operate said at least two pawls.

2. The glove box latch assembly of claim 1, wherein said handle assembly includes a housing having at least one arm aperture where said housing retains said handle and at least one actuating arm therein.

3. The glove box latch assembly of claim 1, wherein said latch assembly includes a pawl cover to encase the latch assembly.

4. The glove box latch assembly of claim 3, wherein said pawl cover includes at least two pawl apertures for receiving said at least two pawls there through.

5. The glove box latch assembly of claim 1, wherein said latch assembly includes a spring to bias said locking feature with a glove box.

6. The glove box latch assembly of claim 2, wherein said back plate includes at least one attachment feature.

7. The glove box latch assembly of claim 6, wherein said at least one attachment feature is of a Christmas tree style.

8. The glove box latch assembly of claim 6, wherein said housing includes at least one attachment aperture.

9. The glove box latch assembly of claim 8, wherein said housing assembly and said latch assembly are secured together via the engagement of said at least one attachment feature within said at least one attachment aperture of said housing.

10. The glove box latch assembly of claim 1, wherein a glove box door is located between said handle assembly and said latch assembly.

11. A glove box latch assembly for latching a glove box door to a glove box, said latch assembly comprising:
a handle assembly comprising at least one actuating arm extending outwardly therefrom;
a latch assembly attached to said handle assembly, said latch assembly comprising:
a back plate comprising at least one arm aperture;
a locking feature comprising an engagement section and a pair of pawls; and
wherein said at least one actuating arm engages with said engagement feature to operate said pair of pawls.

12. The glove box latch assembly of claim 11, wherein said handle assembly includes a housing and a lifting portion.

13. The glove box latch assembly of claim 11, wherein said latch assembly includes a spring to bias said pair of pawls in a closed or open position.

14. The glove box latch assembly of claim 11, wherein said latch assembly includes a pawl cover secured to said back plate.

15. The glove box latch assembly of claim 12, wherein said housing includes at least one bumper.

16. The glove box latch assembly of claim 15, wherein said at least one bumper reduces noise and impact resulting from any contact between said lifting portion and said housing during use.

17. The glove box latch assembly of claim 11, wherein said glove box door is located between said handle assembly and said latch assembly.
